(19) United States
(12) Patent Application Publication
(10) Pub. No.: US 2025/0361434 A1
(43) Pub. Date: Nov. 27, 2025

(54) METHOD AND SYSTEM FOR IN-SITU SEQUESTRATION AND MINERALIZATION OF CARBON DIOXIDE

(71) Applicant: SAUDI ARABIAN OIL COMPANY, Dhahran (SA)

(72) Inventors: Xiaoxing Wang, Richmond, TX (US); Feng Liang, Houston, TX (US); Jin-Hong Chen, Katy, TX (US)

(73) Assignee: ARAMCO SERVICES COMPANY, Houston, TX (US)

(21) Appl. No.: 18/672,805

(22) Filed: May 23, 2024

(51) Int. Cl. C09K 8/05; C01F 5/24

(52) U.S. Cl. CPC C09K 8/05; C01F 5/24

(57) ABSTRACT

A method for in-situ sequestration and mineralization of CO₂ includes providing an olivine formation having a temperature of 100 to 200° C., at least one injection wellbore that connects a ground surface and the formation, and providing an aqueous fluid to the formation. The method further includes introducing a pH adjuster to the formation to adjust pH of the aqueous fluid to the range of from 7 to 8, injecting CO₂ into the subterranean formation through the injection wellbore, dissolving CO₂ in the aqueous fluid, and reacting CO₂ with magnesium in the olivine. A system for in-situ sequestration and mineralization of CO₂ includes an olivine formation, an aquifer in a vicinity of the formation, at least one injection wellbore configured to inject CO₂ into the formation, and at least one transfer wellbore connecting the injection wellbore and the aquifer to provide an aqueous fluid from the aquifer to the formation.

### BACKGROUND

Continuous emission of carbon dioxide (CO₂) through combustion of organic compounds, such as fossil fuel, has resulted in increased CO₂ concentration in the atmosphere, and global climate change. In an attempt to reduce CO₂ emission, alternative energy generation method and carbon capture, utilization, and sequestration (CCUS) technology have been proposed and developed.

In the field of CCUS, CO₂ mineralization is one of the most promising processes to mitigate the CO₂ emission and associated climate change. CO₂ mineralization is a process to covert CO₂ gas into stable solid inorganic carbonates (e.g., minerals) as a way to store CO₂ in non-gaseous form. CO₂ mineralization is an exothermic reaction and thus, does not require a large amount of energy input. In addition, there is abundance of suitable minerals and rocks, such as mafic and ultramafic rocks, available throughout the world that can be used for CO₂ mineralization.

Among the suitable minerals and rocks, olivine is one of the most common minerals on earth, making up between 60 and 80% of the earth's mantle, and can be found in various geological locations. Olivine is a green-colored magnesium-iron silicate represented by a formula ((Mg,Fe)₂SiO₄) and may have a crystal size between 0.01 mm and 2 mm. Olivine is considered to be environmentally-friendly, and does not generally pose adverse health and safety effects on living organisms including human. Furthermore, one pound of olivine may be capable of absorbing up to one pound of CO₂. Thus, olivine is considered as one of the suitable material for CO₂ sequestration via mineralization process.

However, CO₂ sequestration of olivine is often conducted outside of the subterranean reservoirs. Accordingly, there exists a need for the development of in-situ CO₂ sequestration and mineralization method and system using subterranean formations including minerals such as olivine.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for in-situ sequestration and mineralization of CO₂. The method includes providing a subterranean formation including olivine and having an elevated temperature in a range of from 100° C. to 200° C., providing at least one injection wellbore that connects a ground surface and the subterranean formation, and providing an aqueous fluid to the subterranean formation. The method further includes introducing a pH adjuster to the subterranean formation to adjust a pH of the aqueous fluid to a range of from 7 to 8, injecting CO₂ into the subterranean formation through the at least one injection wellbore, dissolving CO₂ in the aqueous fluid, and reacting CO₂ at least with magnesium comprised in the olivine under the elevated temperature to produce a solid magnesium-based compound.

In another aspect, embodiments disclosed herein relate to a system for in-situ sequestration and mineralization of CO₂. The system includes a subterranean formation including olivine, an aquifer in a vicinity of the subterranean formation, at least one injection wellbore connecting a ground surface and the subterranean formation and configured to inject CO₂ into the subterranean formation, and at least one transfer wellbore connecting the at least one injection wellbore and the aquifer and configured to provide an aqueous fluid from the aquifer to the subterranean formation.

Other aspects and advantages of the claimed subject matter will be apparent from the following description and the appended claims.

### BRIEF DESCRIPTION OF THE DRAWINGS

FIG. 1 is a system for in-situ sequestration and mineralization of CO₂ in accordance with one or more embodiments.

FIG. 2 is a system for in-situ sequestration and mineralization of CO₂ in accordance with one or more embodiments.

FIG. 3 is a system for in-situ sequestration and mineralization of CO₂ in accordance with one or more embodiments.

FIGS. 4A-4B is a system for in-situ sequestration and mineralization of CO₂ in accordance with one or more embodiments.

FIG. 5 is a system for in-situ sequestration and mineralization of CO₂ in accordance with one or more embodiments.

FIG. 6 is a flow diagram showing the method for in-situ sequestration and mineralization off CO₂ in accordance with one or more embodiments.

FIG. 7 is a flow diagram showing the method for in-situ sequestration and mineralization off CO₂ in accordance with one or more embodiments.

### DETAILED DESCRIPTION

### System for In-Situ Sequestration and Mineralization of CO₂

In one aspect, embodiments disclosed herein relates to a system for in-situ sequestration and mineralization of CO₂. The system includes a subterranean formation including olivine, and at least one injection wellbore connecting a ground surface and the subterranean formation and configured to inject CO₂ into the subterranean formation.

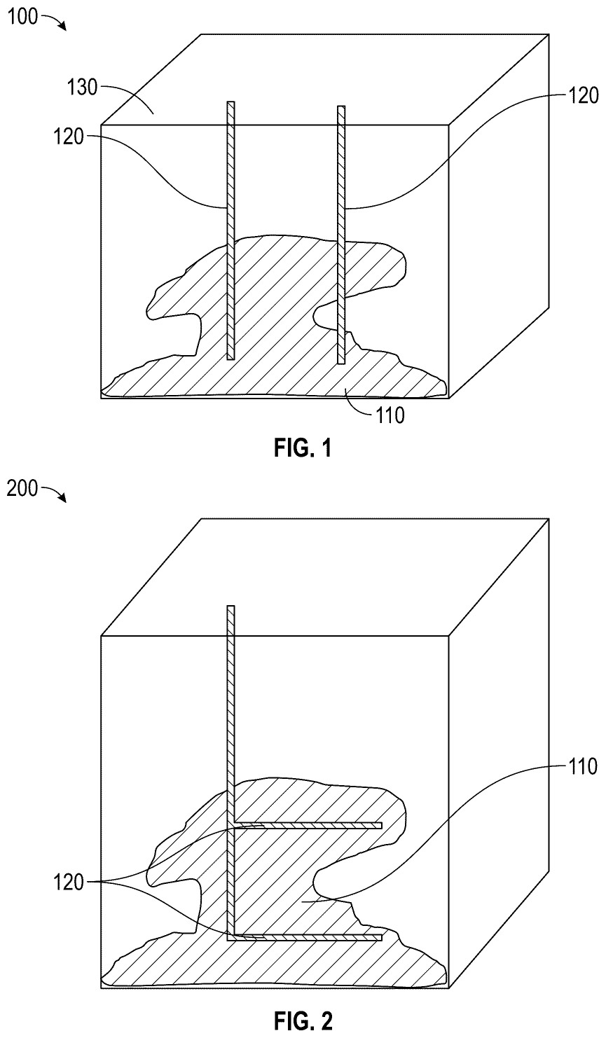

FIG. 1 is a schematic diagram of the system for in-situ sequestration and mineralization of CO₂ according to one or more embodiments. The system 100 includes a subterranean formation that includes olivine (“olivine formation”) 110, and at least one injection wellbore (“injection wellbore”) 120 connecting the ground surface 130 and the olivine formation 110.

In the present disclosure, a “subterranean formation” refers to a rock formation that resides underground. The rock formation may be porous or fractured such that a fluid may penetrate into the rock formation. The subterranean formation may be a water-bearing formation (which may include fresh water and brine), hydrocarbon-bearing formation, or combinations thereof. The ground surface 130 may be a surface of a dry land, or a surface of a land located at the bottom of a body of water, such as ocean.

The olivine formation 110 may have an elevated temperature. The temperature of the olivine formation 110 may be in a range of from about 100° C. to about 200° C., such as in a range from a lower limit selected from any one of 100, 120, 140, 150, and 160° C. to an upper limit selected from any one of 150, 180, and 200° C., where any lower limit may be paired with any mathematically compatible upper limit. The temperature of the olivine formation 110 may be about 175° C. The temperature of the olivine formation 110 may naturally be in the aforementioned range due to the geothermal heat. In one or more embodiments, the olivine formation 110 is heated to have a temperature in the above range. An olivine formation 110 having an elevated temperature in the aforementioned range may increase the reaction rate of CO₂ with olivine and enhance the CO₂ mineralization process.

The injection wellbore 120 may be configured to inject CO₂ into the olivine formation 110. The injection of CO₂ may be conducted by a suitable method and equipment available in the art, such as a pump. The injection wellbore 120 may also be configured to inject an aqueous fluid, such as water and steam, into the olivine formation 110.

The injection wellbore 120 may include at least one vertical wellbore, at least one horizontal wellbore, or combinations thereof. For example, the system 200 in FIG. 2 includes the injection wellbore 120 having a vertical wellbore, and a plurality of horizontal wellbores connected to the vertical wellbore. Injection of high temperature fluid into horizontal wellbores may provide a very efficient sequestration and mineralization of CO₂ because it simultaneously injects both water and heat into the olivine formation 110. The number and configuration of the injection wellbore 120 may be determined based on specific needs of each application.

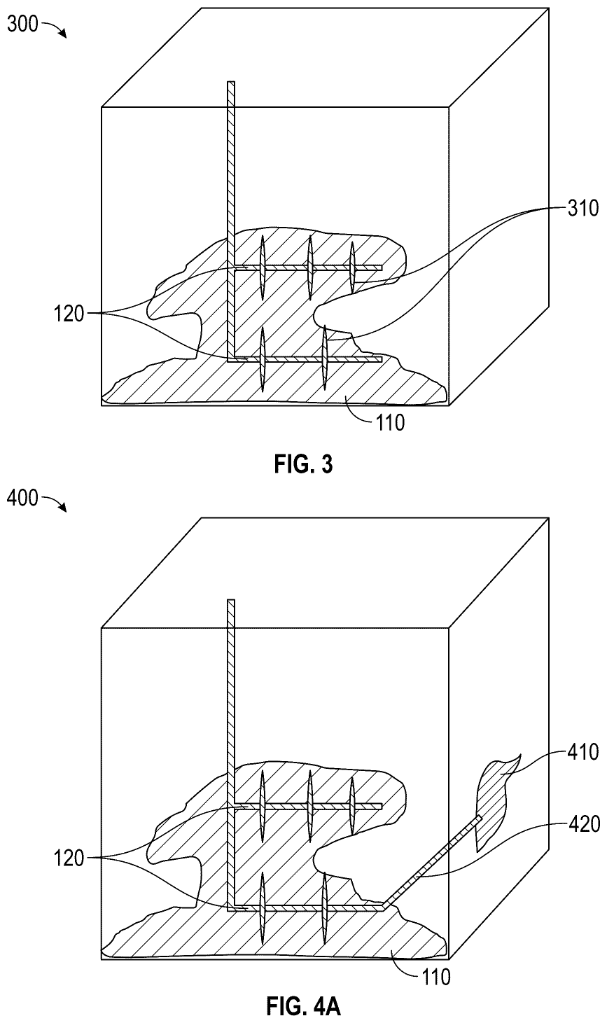

The olivine formation 110 may include fractures. FIG. 3 illustrates a system 300 of one or more embodiments in which the olivine formation 110 includes fractures 310. The fractures 310 may be naturally-occurring fractures, or may be formed through hydraulic fracturing. The hydraulic fracturing may be conducted via methods available in the art, such as injecting acidic fluid under an elevated pressure into the injection wellbore 120. An olivine formation 110 including fractures 310 may provide increased contact area between the injected fluid, such as an aqueous fluid and CO₂, with olivine, and may result in improved CO₂ diffusion into olivine and reaction of CO₂ with olivine and consequently, improved CO₂ sequestration and mineralization process.

In one or more embodiments, the system includes an aquifer in a vicinity of the subterranean formation including olivine and at least one transfer wellbore connecting the at least one injection wellbore and the aquifer. The transfer wellbore is configured to provide an aqueous fluid from the aquifer to the olivine formation 110.

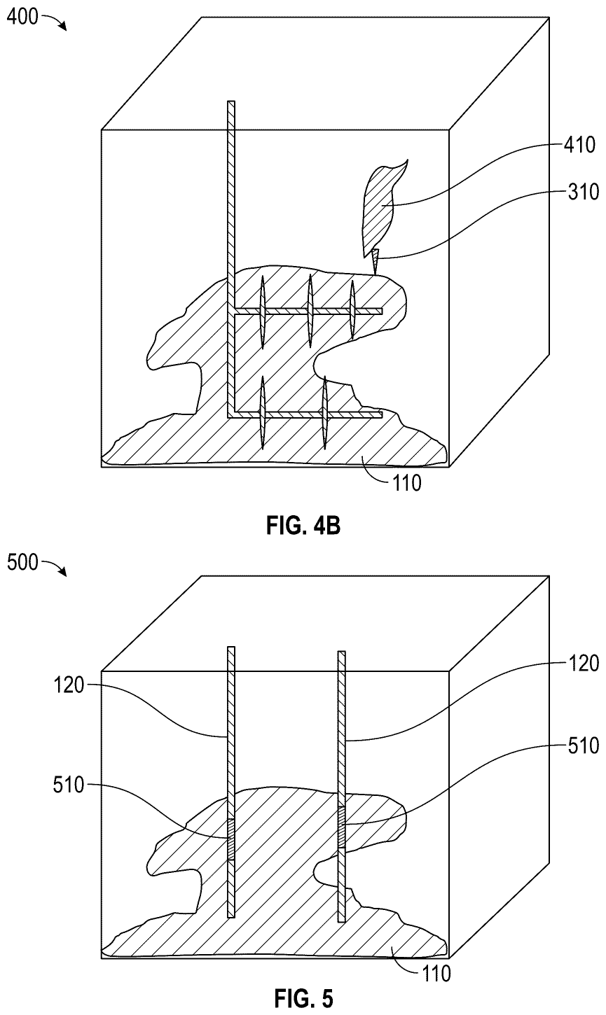

FIG. 4A illustrates a system 400 of one or more embodiments that includes an aquifer 410 and at least one transfer wellbore (“transfer wellbore”) 420 that connects the injection wellbore 120 and the aquifer 410. An aqueous fluid, such as water, flows from the aquifer 410 through the transfer wellbore 420 and into the olivine formation 110. The aqueous fluid from the aquifer 410 that flows through the transfer wellbore 420 may first flow into the injection wellbore 120 prior to flowing into the olivine formation 110, or may directly flow into the olivine formation 110 from the transfer wellbore 420. The use of aqueous fluid from the aquifer 410 may provide cost and energy saving which results from external injection of aqueous fluid.

An aquifer 410 in the “vicinity” of the olivine formation 110 refers to an aquifer 410 located at a distance in a range of about from 1 m to 10 km from the olivine formation 110, such as in a range of from a lower limit selected from any one of 1 m, 5 m, 10 m, 20 m, 50 m, and 100 m, to an upper limit selected from any one of 5 m, 10 m, 50 m, 100 m, 500 m, 1 km, 5 km and 10 km, where any lower limit may be paired with any mathematically compatible upper limit.

The transfer wellbore 420 may be at least one horizontal wellbore, at least one vertical wellbore, or combinations thereof.

In one or more embodiments, the aqueous fluid from the aquifer 410 is directly provided to the olivine formation 110 without the transfer wellbore 420 via naturally-formed or artificially-formed fractures in the olivine formation 110. The artificially-formed fractures may be fractures formed by hydraulic fracturing operation.

FIG. 4B illustrates a system 400 of one or more embodiments that includes an aquifer 410 in which the aqueous fluid from the aquifer 410 is provided to the olivine formation 110 via fractures 310 in the olivine formation 110.

In one or more embodiments, the aqueous fluid is provided to the olivine formation 110 by the transfer wellbore 420 and fractures 310.

The flow rate of the aqueous fluid flowing from the aquifer 410 to the injection wellbore 120 may be controlled based on the diameter of the transfer wellbore 420, or the pore size of the fractures 310 that provide the aqueous fluid to the olivine formation 110 from the aquifer 410.

In one or more embodiments, the system further includes a heat generator placed in the injection wellbore and configured to heat the olivine formation to a temperature in a range of about 100 to 200° C., such as in a range of from a lower limit selected from any one of 100, 120, 140, 150 and 160° C. to an upper limit selected from any one of 150, 180, and 200° C., where any lower limit may be paired with any mathematically compatible upper limit. FIG. 5 illustrates a system 500 of one or more embodiments that includes a heat generator 510 placed in the injection wellbore 120. The heat generator 510 heats the olivine formation 110 such that the reaction of CO₂ with olivine may take place under an elevated temperature.

The number of heat generators 510 in each injection wellbore 120, and whether a specific injection wellbore 120 requires a heat generator 510 or not may be determined based on the requirements of each application. In one or more embodiments, at least one injection wellbore includes the heat generator 510. In one or more embodiments, all injection wellbores include the heat generator 510.

Specific examples of the heat generator 510 may include, but are not limited to, a heating pipe, electrodes, electromagnetic wave generator, a heating element and combinations thereof.

The heating pipe may be placed in the injection wellbore and electric current may be passed through the pipe to heat the pipe. The olivine formation 110 is then heated by the conductive heat from the heating pipe. The heat may further transfer within the olivine formation 110 through thermal diffusion.

In one or more embodiments, electrodes are placed in the injection wellbore 120, such as at the bottom of the injection wellbore 120, and electricity is conducted through the electrodes to generate heat directly in the olivine formation 110. The amount of generated heat may be determined by the density of the provided electrical current and the electromagnetic property of the olivine formation 110.

In one or more embodiments, an electromagnetic wave generator may be placed in the injection wellbore 120 which applies electromagnetic waves to the olivine formation 110 and heats the olivine formation 110. The heat may further transfer within the olivine formation 110 through thermal diffusion.

In one or more embodiments, a heating element may be placed in the injection wellbore 120 which may be used to heat the olivine formation 110 and aqueous fluid in the injection wellbore 120.

### Method for In-Situ Sequestration and Mineralization of CO₂

In one aspect, embodiments disclosed herein relates to a method for in-situ sequestration and mineralization of CO₂. The method includes providing a subterranean formation including olivine and having an elevated temperature in a range of from 100 to 200° C., providing at least one injection wellbore that connects a ground surface and the subterranean formation. The method further includes providing an aqueous fluid to the subterranean formation, introducing a pH adjuster to the subterranean formation, injecting CO₂ into the subterranean formation through the at least one injection wellbore, dissolve carbon dioxide in the aqueous fluid, and reacting carbon dioxide with magnesium comprised in the olivine under the elevated temperature to produce a solid magnesium-based compound.

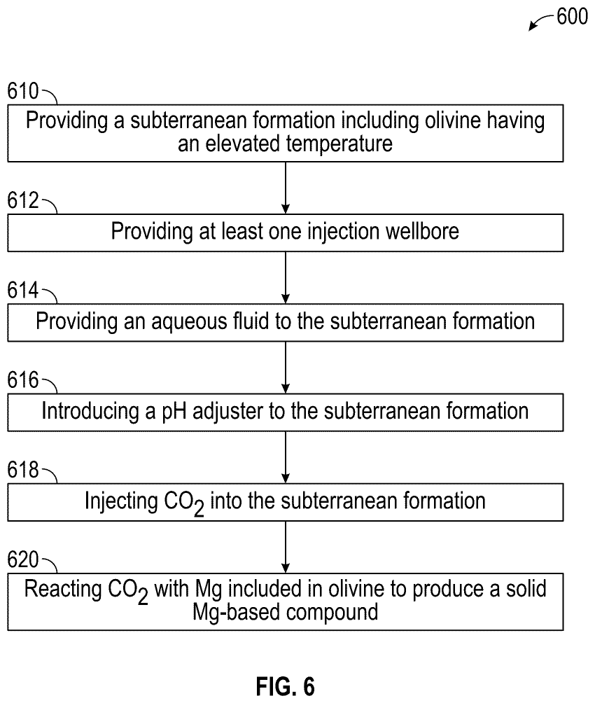

FIG. 6 is a flow diagram showing the method for in-situ sequestration and mineralization of CO₂ of one or more embodiments. The method 600 includes providing a subterranean formation including olivine (olivine formation) 110 (step 610). The olivine formation 110 has an elevated temperature in a range of from about 100 to about 150° C. or from about 100 to about 200° C., such as in a range of from a lower limit selected from any one of 100, 120, 140, 150 and 160° C. to an upper limit selected from any one of 150, 180, and 200° C., where any lower limit may be paired with any mathematically compatible upper limit. A higher temperature may accelerate the dissolution of olivine and increase the reaction rate of the CO₂ mineralization process. An increase in the temperature also reduces the solubility of CO₂. An olivine formation 110 having a temperature in the aforementioned range may provide an optimized CO₂ mineralization process.

The method includes providing at least one injection wellbore (injection wellbore) 120 that connects a ground surface 130 and the olivine formation 110 (step 612). The injection wellbore 120 may be any of the injection wellbore 120 as previously described.

An aqueous fluid is then provided to the olivine formation 110 (Step 614). Provision of aqueous fluid may improve the reaction kinetics of CO₂ sequestration and mineralization process. A pH adjuster is then introduced to the olivine formation 110 (Step 616). CO₂ is injected into the olivine formation 110 (Step 618) and the injected CO₂ is reacted at least with magnesium (Mg) included in olivine under the elected temperature (Step 620). The reaction of CO₂ with Mg results in the formation of a solid magnesium-based compound, such as magnesium carbonate (MgCO₃), thereby sequestering CO₂ by converting CO₂ into a solid form. CO₂ injected into the olivine formation 110 may also react with Fe to produce Fe₂(CO₃)₃.

The provision of the aqueous fluid to the olivine formation 110 (Step 614) may be conducted by introducing the aqueous fluid through the injection wellbore 120. In one or more embodiments, the aqueous fluid is introduced to the olivine formation 110 from an aquifer 410 through a transfer wellbore 420 which connects the aquifer 410 and the injection wellbore 120. The aquifer 410 may be located in the vicinity of the injection wellbore 120. In one or more embodiments, the aqueous fluid is provided by providing an olivine formation 110 which includes a sufficient amount of the aqueous fluid for CO₂ sequestration and mineralization. The provision of the aqueous fluid may be combinations of any of the methods described above.

The aqueous fluid may contain water, and may contain additives such as a pH adjuster including sodium bicarbonate (NaHCO₃), trisodium nitrilotriacetate (NTA, C₆H₆Na₃O₆), monosodium phosphate (NaH₂PO₄) and combinations thereof. The pH adjuster may counteract the acidification that occurs due to the dissolution of injected CO₂ and maintain the pH of the aqueous fluid in the optimum range, such as in a range of from about 7 to about 8, for the reaction of CO₂ with olivine. An aqueous fluid having a low pH, such as lower than 6, may cause the dissolution of formed solid Mg-based compound, hindering the mineralization process of CO₂. By having the pH of the aqueous fluid in the optimum range, dissolution of Mg-cased compound may be prevented or minimized, further enhancing the CO₂ sequestration and mineralization process. The aqueous fluid may further contain substances such as NaCl, KCl, MgCl₂ and CaCl₂).

In one or more embodiments, the aqueous fluid is a liquid (such as water or brine), a gas (such as steam) or combinations thereof. The aqueous fluid may be heated (such as heated steam) and then introduced to the olivine formation 110, or may be heated in the injection wellbore 120 with a heat generator 510 as previously described.

The additives, such as pH adjusters, and the aqueous fluid may be introduced to the olivine formation 110 simultaneously or separately. The specific introduction method of the additives and the aqueous fluid may be determined based on the specific requirements of each application. For example, the additives may be pre-dissolved in the aqueous fluid and then introduced to the olivine formation 110 via the injection wellbore 120. In one or more embodiments, the aqueous fluid without additives is introduced to the olivine formation 110 and then the additives are introduced to the olivine formation 110 subsequently through the injection wellbore 120. In one or more embodiments, the aqueous fluid without the additives is introduced to the olivine formation 110 from an aquifer 410 and the additives are introduced to the olivine formation 110 via the injection wellbore 120.

The injection of CO₂ into the olivine formation 110 (Step 218) may be conducted through the injection wellbore 120 using a method known in the art. In one or more embodiments, CO₂ is injected at an elevated pressure, such as at a pressure in a range of from about 1000 to about 4000 psig, or in a range of from a lower limit selected from any one of 1000, 1500, 2000, and 3000 psig to an upper limit selected from any one of 2000, 3000 and 4000 psig, where any lower limit may be paired with any mathematically compatible upper limit. A higher CO₂ injection pressure may lead to a higher solubility of CO₂ in the aqueous fluid, which may improve the CO₂ mineralization process. Furthermore, a higher CO₂ pressure may lower the pH, which may help dissolve olivine and improve the rate of CO₂ mineralization. However, as previously described, pH below the optimum range may inhibit the CO₂ mineralization process due to the dissolution of formed solid Mg-based compound.

The reaction of CO₂ with Mg contained in olivine to produce a solid Mg-based compound (step 620) may be conducted at a temperature in a range of from about ° C. to about 200° C., such as in a range of from a lower limit selected from any one of 100, 120, 140, 150 and 160° C. to an upper limit selected from any one of 150, 180, and 200° C., where any lower limit may be paired with any mathematically compatible upper limit. for optimum mineralization of CO₂. The reaction of CO₂ and olivine may be influenced by various factors including, but are not limited to, presence or absence of water, temperature, pressure of CO₂, pH of the aqueous fluid, ions present in the water.

Reaction of gaseous CO₂ with olivine may be expressed by the following equation:

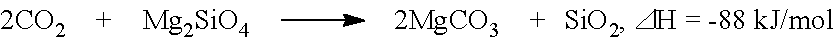

The reaction is a thermodynamically-favored reaction and the products are chemically stable and environmentally benign. The reaction of gaseous CO₂ and olivine is generally considered as a slow reaction, limited by diffusion of CO₂ at ambient conditions.

With the presence of water, CO₂ mineralization process with olivine may be expressed by the following equations:

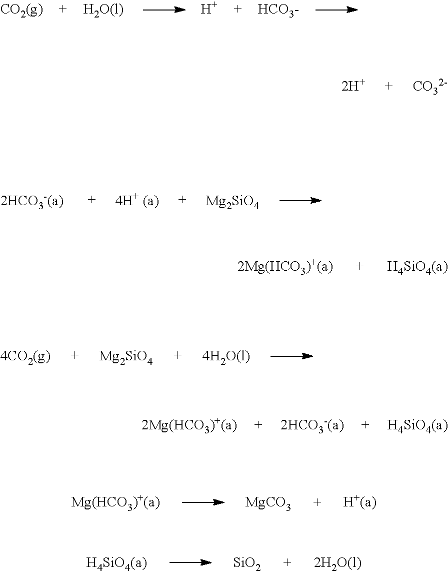

The presence of water changes the reaction interface from gas/solid to gas/liquid/solid, as the CO₂ dissolved into the aqueous fluid, which promotes the reaction kinetics.

In one or more embodiments, the method additionally includes any of the following steps of providing at least one transfer wellbore 420, fracturing the olivine formation 110, obtaining the temperature and water content of the olivine formation 110, and heating the olivine formation 110.

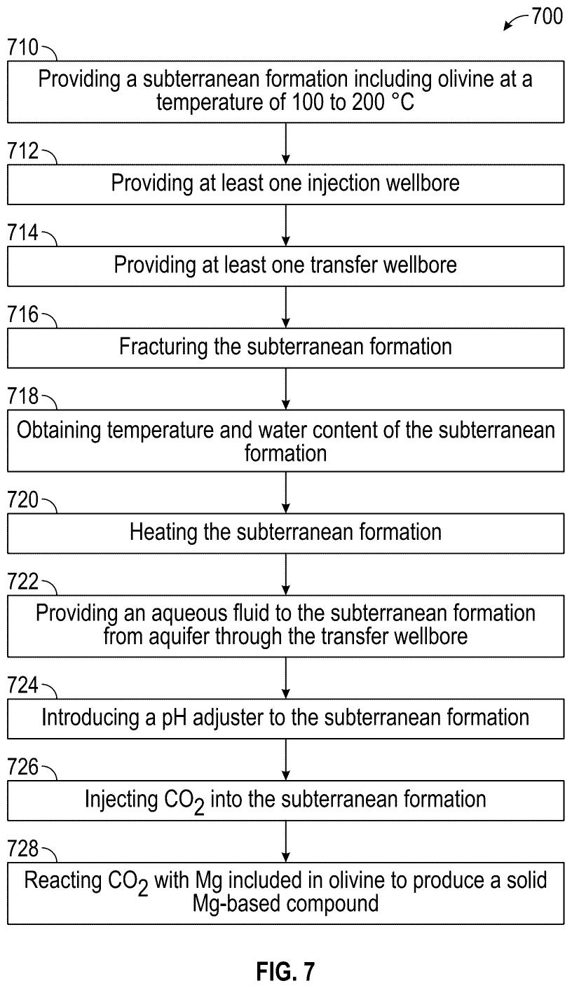

FIG. 7 is a flow diagram showing the method for in-situ sequestration and mineralization of CO₂ of one or more embodiments. The method 700 includes providing a subterranean formation including olivine (olivine formation) 110 (step 710) and providing at least one injection wellbore 120 (step 712) as previously described. The method 700 further includes providing at least one transfer wellbore 420 that connects the at least one injection wellbore 120 and an aquifer 410 located in the vicinity of the olivine formation 110 (step 714). The method includes fracturing the olivine formation 110, which may be conducted prior to providing an aqueous fluid and injecting CO₂ into the olivine formation 110 (step 716). The method also includes obtaining the temperature and water content of the olivine formation 110 (step 718) and heating the olivine formation 110 (step 720). The method further includes providing an aqueous fluid to olivine formation 110 from the aquifer 410 through the transfer wellbore 420 (step 722). The method includes introducing a pH adjuster to the olivine formation 110 (step 724), injecting CO₂ into the olivine formation 110 (step 726) and reacting CO₂ with Mg included in the olivine formation 110 to produce a solid Mg-based compound (step 728), as previously described.

The step of providing at least one transfer wellbore 420 (step 714) may be conducted by drilling the transfer wellbore 420 from the injection wellbore 120, or may be conducted by drilling the transfer wellbore 420 from the aquifer 410 to the injection wellbore 120.

The fracturing process of the olivine formation 110 (step 716) may be conducted by the methods known in the art, such as a hydraulic fracturing process. Fracturing of the olivine formation 110 may provide increased contact area between the injected fluid, such as an aqueous fluid and CO₂, with olivine and improved CO₂ sequestration and mineralization process, as previously described.

The step of obtaining the temperature and the water content of the olivine formation 110 (step 718) may be conducted to determine the required amount of heat needed for the olivine formation 110 to be in the elevated temperature range of about 100 to about 200° C., such as in a range of from a lower limit selected from any one of 100, 120, 140, 150 and 160° C. to an upper limit selected from any one of 150, 180, and 200° C., where any lower limit may be paired with any mathematically compatible upper limit, and the required amount of the aqueous fluid provided to the olivine formation 110. The temperature of the olivine formation 110 may be obtained by, for example, placing a device including a temperature probe, IR temperature detector and a wellbore sensor in the olivine formation 110. In case the olivine formation 110 is naturally at an elevated temperature, such as a temperature in a range of from about 100 to about 200° C., the method may be conducted without the heating step of the olivine formation 110.

The water content may be obtained by, for example, taking a core sample from the olivine formation 110 and determining the core sample weight change by placing the core sample under an elevated temperature, such as 100° C., for a specific amount of time, or until no weight reduction can be seen. The water content may also be obtained by other methods known in the art.

The heating step of the olivine formation 110 (step 720) may be conducted by various processes. The heating may be conducted by injecting a heated fluid into the olivine formation 110. The heated fluid may be a heated aqueous fluid or a heated CO₂ that are used in the CO₂ sequestration and mineralization process, or combinations thereof. Use of the aqueous fluid and/or CO₂ as the medium to introduce additional heat to the olivine formation 110 may provide cost-effective and energy-efficient CO₂ sequestration and mineralization process because the heat-carrying medium is also used in the mineralization process. The heated aqueous fluid may be heated steam. The heated fluid may be a fluid other than the aqueous fluid and CO₂. The injection of the heated fluid may be conducted continuously or intermittently during the CO₂ sequestration and mineralization process.

In one or more embodiments, the heating of the olivine formation 110 is conducted by a heat generator 510 placed in the injection wellbore 120, such as at the bottom of the injection wellbore 120, or the back section of the vertical injection wellbore 120. As previously described, the heat generator 510 may include, but is not limited to, a heating pipe, electrodes, electromagnetic wave generator, a heating element and combinations thereof. Use of the heat generator 510 to heat the olivine formation 110 may reduce the operational and capital costs required for the heating process compared to the heating of the olivine formation 110 via heated fluid injection.

In one or more embodiments, the heating of the olivine formation 110 is conducted by irradiating the olivine formation 110 with electromagnetic waves. The irradiation of the olivine formation 110 with electromagnetic waves may be conducted by an electromagnetic wave generator placed in the injection wellbore 120. In one or more embodiments, the source of the electromagnetic waves may be located outside of the injection wellbore 120, such as at the ground surface 130, allowing remote heating of the olivine formation 110.

In one or more embodiments, the heating of the olivine formation 110 is conducted by electrical conduction. Heating of the olivine formation 110 via electrical conduction may be conducted by, for example, installing electrodes in the injection wellbore 120, such as at the bottom of the injection wellbore 120, or the back section of the vertical injection wellbore 120, and introducing electrical current through the electrodes and the olivine formation 110. The amount of generated heat may depend on factors such as an electrical current density, and the electromagnetic property of the olivine formation 110.

The step of providing an aqueous fluid to the olivine formation (step 722) may be conducted by introducing the aqueous fluid from the aquifer 410 to the olivine formation 110 through the at least one transfer wellbore 420. As previously described, the aqueous fluid from aquifer 410 may be provided through the injection wellbore 120 before being introduced to the olivine formation 110, or may be directly introduced form the transfer wellbore 420 into the olivine formation 110. The use of aqueous fluid from the aquifer 410 may provide cost and energy saving which results from external injection of aqueous fluid.

The introduction step of pH adjuster to olivine formation 110 (step 724), injection step of CO₂ into olivine formation 110 (step 726), and reaction step of CO₂ with Mg in olivine formation 110 (step 728) may be conducted as previously described.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke means-plus-function for any limitations of any of the claims herein, except for those in which the claim expressly uses the words ‘means for’ together with an associated function.

What is claimed is:

1. A method for in-situ sequestration and mineralization of carbon dioxide, comprising:
providing a subterranean formation comprising olivine and having an elevated temperature in a range of from 100° C. to 200° C.;
providing at least one injection wellbore that connects a ground surface and the subterranean formation;
providing an aqueous fluid to the subterranean formation;
introducing a pH adjuster to the subterranean formation to adjust a pH of the aqueous fluid to a range of from 7 to 8;
injecting carbon dioxide into the subterranean formation through the at least one injection wellbore;
dissolving carbon dioxide in the aqueous fluid; and
reacting carbon dioxide at least with magnesium comprised in the olivine under the elevated temperature to produce a solid magnesium-based compound.

2. The method of claim 1, wherein the elevated temperature is provided by heating the subterranean formation.

3. The method of claim 2, wherein the heating is conducted by injecting a heated fluid into the subterranean formation.

4. The method of claim 3, wherein the heated fluid is heated steam.

5. The method of claim 2, further comprising placing a heat generator in the injection wellbore and heating the subterranean formation with the heat generator.

6. The method of claim 2, wherein the heating is conducted by one or more selected from the group consisting of irradiation with electromagnetic waves and electrical conduction heating.

7. The method of claim 1, wherein the aqueous fluid introduced to the subterranean formation is obtained from an aquifer located in a vicinity of the subterranean formation.

8. The method of claim 7, wherein the aqueous fluid is directly introduced to the subterranean formation from the aquifer.

9. The method of claim 7, further comprising providing at least one transfer wellbore that connects the at least one injection wellbore and the aquifer, wherein the providing the aqueous fluid is conducted by introducing the aqueous fluid from the aquifer to the subterranean formation through the at least one transfer wellbore.

10. The method of claim 1, further comprising fracturing the subterranean formation prior to introducing the aqueous fluid.

11. The method of claim 1, wherein the pH adjuster comprises sodium bicarbonate, trisodium nitrilotriacetate, or a combination thereof.

12. The method of claim 1, wherein carbon dioxide is injected at a pressure in a range of from 1000 psig to 4000 psig.

13. The method of claim 1, wherein the at least one injection wellbore comprises a vertical wellbore, a horizontal wellbore, or a combination thereof.

14. The method of claim 1, further comprising obtaining a temperature and a water content of the subterranean formation comprising olivine.

15. A system for in-situ sequestration and mineralization of carbon dioxide, comprising:
a subterranean formation comprising olivine;
an aquifer in a vicinity of the subterranean formation;
at least one injection wellbore connecting a ground surface and the subterranean formation and configured to inject carbon dioxide into the subterranean formation;
at least one transfer wellbore connecting the at least one injection wellbore and the aquifer and configured to provide an aqueous fluid from the aquifer to the subterranean formation.

16. The system of claim 15, further comprising a heat generator placed in the at least one injection wellbore and configured to heat the subterranean formation to a temperature in a range of 100° C. to 200° C.

17. The system of claim 16, the heat generator comprises at least one selected from the group consisting of a heating pipe, electrodes, an electromagnetic wave generator, and a heating element.

18. The system of claim 15, wherein the at least one injection wellbore comprises a vertical wellbore, a horizontal wellbore, or a combination thereof.

19. The system of claim 18, wherein:
the at least one injection wellbore comprises a vertical wellbore and at least one horizontal wellbore, and
the at least one transfer wellbore is connected to the at least one horizontal wellbore of the at least one injection wellbore.

20. The system of claim 15, wherein the subterranean formation comprising olivine includes one or more fractures.
